(19) United States
(12) Patent Application Publication
(10) Pub. No.: US 2025/0206580 A1
(43) Pub. Date: Jun. 26, 2025

(54) WORK MACHINE

(71) Applicant: SUMITOMO HEAVY INDUSTRIES, LTD., Tokyo (JP)

(72) Inventor: Yasuhiro YAMAMOTO, Kanagawa (JP)

(21) Appl. No.: 18/985,824

(22) Filed: Dec. 18, 2024

(30) Foreign Application Priority Data
Dec. 22, 2023 (JP) 2023-217121

(51) Int. Cl. B66C 13/48; B66C 23/36

(52) U.S. Cl. CPC B66C 13/48; B66C 23/36; B66C 2700/0371

(57) ABSTRACT

A work machine includes a swivel body configured to be pivotable; a work attachment provided with a boom mounted to the swivel body and configured so as to be raised and lowered; a control device configured to perform automatic control of the swivel body; and a braking device capable of switching between a braking state in which operation of the swivel body is restricted and a non-braking state in which the operation is not restricted. The control device starts or sets the automatic control in a state capable of being started upon switching of the braking device from the braking state to the non-braking state.

### RELATED APPLICATION

The present application is based on and claims priority to Japanese Patent Application No. 2023-217121 filed on Dec. 22, 2023, the entire contents of which are hereby incorporated by reference.

### BACKGROUND

### 1. Field of the Invention

The present disclosure relates to a work machine.

### 2. Description of the Related Art

Conventionally, a crane equipped with a turn anti-sway device is known. In the crane, turn anti-sway control is started when a switch for starting the turn anti-sway control placed in a cab is pressed by an operator.

### SUMMARY

One aspect of the present disclosure provides a work machine including: a swivel body configured to be pivotable; a work attachment provided with a boom mounted to the swivel body and configured so as to be raised and lowered; a control device configured to perform automatic control of the swivel body; and a braking device capable of switching between a braking state in which operation of the swivel body is restricted and a non-braking state in which the operation is not restricted, wherein the control device starts or sets the automatic control in a state capable of being started upon switching of the braking device from the braking state to the non-braking state.

### BRIEF DESCRIPTION OF THE DRAWINGS

FIG. 1 is a block diagram illustrating an embodiment of a work machine according to the present disclosure;

FIG. 2 is a functional block diagram of a control device mounted on the work machine of FIG. 1;

FIG. 3 is a flow diagram illustrating a processing flow of automatic control by the control device of FIG. 2;

FIG. 4 is a side view of a crane as an example of the work machine of FIG. 1;

FIG. 5 is a perspective view around a driver's seat of the crane as illustrated in FIG. 4; and

FIG. 6 is a top view of a swivel body of the crane as illustrated in FIG. 4.

### DETAILED DESCRIPTION

In an existing crane, the turning anti-swing control starts even when an operator mistakenly presses a switch for starting the turning anti-swing control. Therefore, the crane may operate at a timing not intended by the operator.

The present disclosure provides a work machine capable of preventing automatic control from starting at a timing not intended by the operator.

An embodiment of the present disclosure will be described in the following with reference to the drawings.

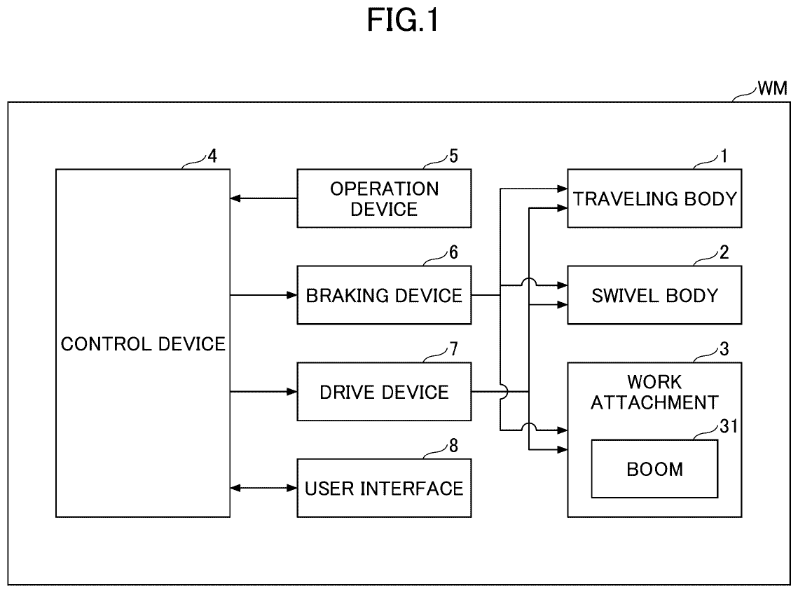

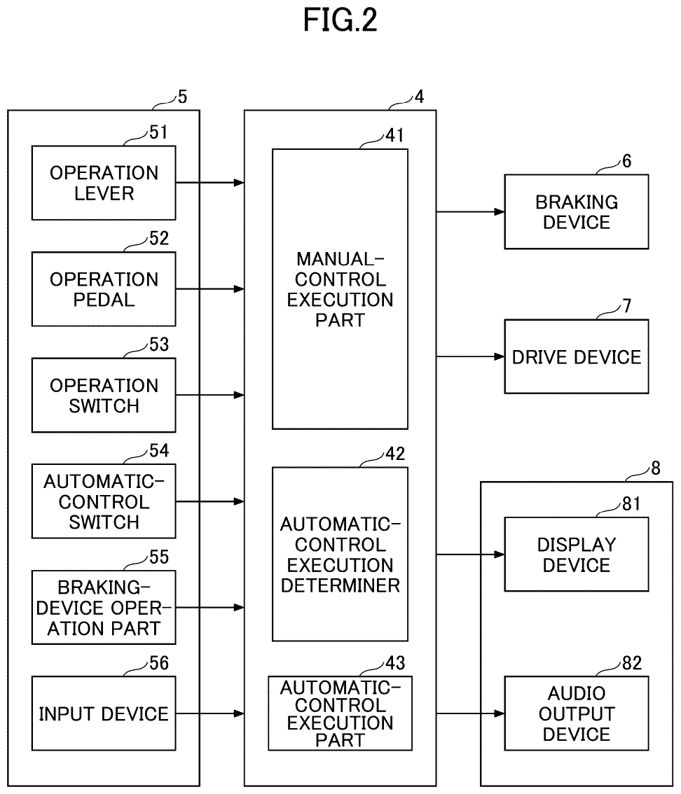

FIG. 1 is a diagram illustrating an embodiment of a work machine according to the present disclosure. FIG. 2 is a functional block diagram of a control device 4 as illustrated in FIG. 1.

A work machine WM of the present embodiment is, for example, a construction machine or a heavy machine such as a shovel or a crane equipped with a work attachment 3 suitable for various work such as ground-leveling work, slope work, excavation work, loading work, dismantling work, crushing work, sorting work, lifting work, or carrying work.

The work machine WM includes, for example, a traveling body 1, a swivel body 2, and a work attachment 3. The work machine WM includes, for example, the control device 4, an operation device 5, a braking device 6, a drive device 7, and a user interface 8.

The traveling body 1 includes, for example, a pair of crawlers driven by a hydraulic motor included in the drive device 7, or a plurality of wheels driven by an engine and a transmission included in the drive device 7, and causes the work machine WM to travel. When the work machine WM is a stationary crane, the work machine WM does not necessarily include the traveling body 1.

The swivel body 2 is mounted, for example, on the traveling body 1 so as to be pivotable. The swivel body 2 is driven by, for example, a hydraulic motor included in the drive device 7, and configured to turn around an axis parallel to a height direction of the work machine WM. When the work machine WM is a stationary crane, the swivel body 2 may be mounted on a base or a mast so as to be pivotable.

The work attachment 3 includes, for example, a boom 31 mounted to the swivel body 2 so as to be raised and lowered. The boom 31 is rotatably mounted to the swivel body 2 via, for example, a boom foot pin parallel to a width direction of the swivel body 2, and is driven and moves up and down by a hydraulic cylinder or a winch, that is included in the drive device 7.

When the work machine WM is a shovel, the work attachment 3 further includes an arm attached to a tip of the boom 31 and an end attachment such as a bucket attached to a tip of the arm.

When the work machine WM is a crane, the work attachment 3 includes, for example, a jib attached to the tip of the boom 31 and a hook suspended from the tip of the boom 31 or the jib by a main rope. When the work machine WM is a crane, the boom 31 attached to the swivel body 2 may be called a “main jib”.

The control device 4 is a controller including, for example, a processing device such as a CPU and a storage device such as a RAM and a ROM. The control device 4 can perform various types of computation based on input information by executing various programs stored in the storage device by the processing device, and can achieve various functions including automatic control of the work machine WM. The control device 4 controls, for example, the braking device 6, the drive device 7, and the user interface 8 based on an operation signal input from the operation device 5.

As illustrated in FIG. 2, the control device 4 includes, for example, a manual-control execution part 41, an automatic-control execution determiner 42, and an automatic-control execution part 43. Each part of the control device 4 represents, for example, functions of the control device 4 that can be achieved by executing programs stored in a memory by the CPU. Each part of the control device 4 may be achieved by one controller or by using multiple controllers, firmware, or hardware.

The operation device 5 includes, for example, an operation lever 51, an operation pedal 52, an operation switch 53, an automatic-control switch 54, a braking-device operation part 55, and an input device 56, as illustrated in FIG. 2. The braking-device operation part 55 includes, for example, a gate lock lever and a turn-braking switch. The input device 56 includes, for example, a keyboard and a touch panel. When the work machine WM has a remote control function, the operation device 5 may be a remote control device connected to the control device 4 via a wireless communication line.

The braking device 6 includes, for example, a traveling brake for braking the traveling body 1. The braking device 6 also includes, for example, a locking mechanism for stopping all operations of the work machine WM when an operation is performed to invalidate the gate lock lever included in the operation device 5. When the work machine WM is a crane, the braking device 6 includes, for example, a turn-braking switch. When the turn-braking switch is pressed, turning of the swivel body 2 is locked or restricted, and a turn-stop state of the swivel body 2 is maintained.

The drive device 7 includes, for example, a power source such as an engine, a hydraulic pump driven by the power source, and a direction control valve for controlling a flow amount and a flow direction of hydraulic fluid pumped by the hydraulic pump. The drive device 7 includes, for example, a pilot pump and a pilot valve for supplying pilot pressure to the direction control valve based on a control signal input from the control device 4.

The drive device 7 also includes, for example, a hydraulic actuator driven by the hydraulic fluid pumped from the hydraulic pump via the direction control valve. The hydraulic actuator includes, for example, a hydraulic cylinder and a hydraulic motor. The drive device 7 actuates the traveling body 1, the swivel body 2, and the work attachment 3 by driving the hydraulic actuator based on a control signal input from the control device 4, for example.

The user interface 8 includes, for example, a display device such as a liquid crystal display device or an organic EL display device, and an audio output device such as a speaker.

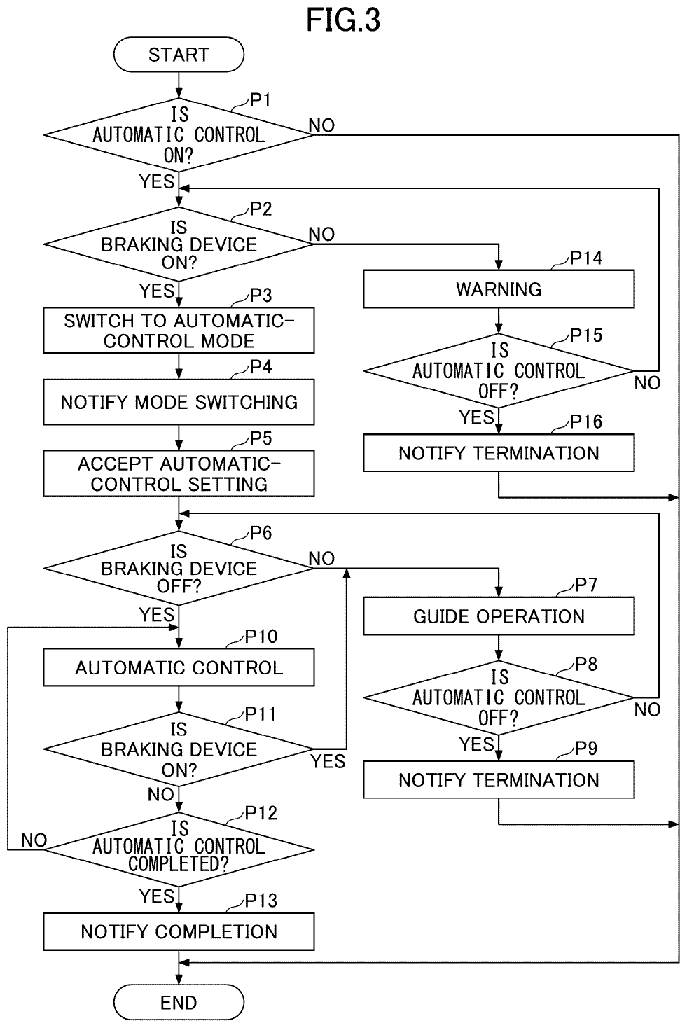

An example of the operation of the control device 4 mounted on the work machine WM as illustrated in FIG. 1 will be described in the following with reference to FIG. 3. FIG. 3 is a flow diagram illustrating a processing flow of automatic control by each part of the control device 4 as illustrated in FIG. 2.

When a start switch of the work machine WM is turned on and the engine of the drive device 7 is started, for example, the control device 4 repeatedly executes the processing in the processing flow as illustrated in FIG. 3 in a predetermined cycle by the automatic-control execution determiner 42. When the processing flow as illustrated in FIG. 3 is started, the automatic-control execution determiner 42 first executes processing P1 to determine whether or not the automatic control is turned on.

In this processing P1, when the operator has not turned on the automatic-control switch 54, the automatic-control execution determiner 42 determines that the automatic control is not turned on (NO) and ends the processing flow as illustrated in FIG. 3. In this case, a mode of the work machine WM is maintained in a manual operation mode, and when the operator operates the operation lever 51, the operation pedal 52, the operation switch 53, etc., of the operation device 5, an operation signal corresponding to the operation is input to the manual-control execution part 41 of the control device 4.

In the manual operation mode of the work machine WM, the manual-control execution part 41 outputs a control signal to the braking device 6 and the drive device 7 based on the operation signal input from the operation device 5. As a result, the traveling body 1, the swivel body 2, and the work attachment 3 of the work machine WM as illustrated in FIG. 1 are driven or braked according to the operation of the operator, and the work attachment 3 including the boom 31 mounted to the swivel body 2 so as to be raised and lowered can perform the predetermined operation as described above.

Additionally, when the operator switches the mode of the work machine WM from the manual operation mode to an automatic-control mode by turning on the automatic-control switch 54, from the viewpoint of safety, it is required to switch the mode of the work machine WM while the operation of the work machine WM is restricted by operating the braking device 6.

Therefore, when the operator of the work machine WM intentionally switches the manual operation mode to the automatic-control mode, for example, the operator operates the gate lock lever and the turn-braking switch included in the braking-device operation part 55 of the operation device 5. As a result, an operation signal for operating the braking device 6 is input from the braking-device operation part 55 to the control device 4.

The manual-control execution part 41 of the control device 4 outputs to the braking device 6, for example, a control signal corresponding to the operation signal input from the braking-device operation part 55, and operates the braking device 6 according to the operation of the braking-device operation part 55 by the operator. As a result, the braking device 6 switches from, for example, an unrestricted state in which the operation of the traveling body 1, the swivel body 2, and the work attachment 3 is not restricted to a braking state in which the operation of at least the swivel body 2 is restricted.

Then, the operator, for example, presses the automatic-control switch 54 included in the operation device 5 while the braking device 6 is set to perform braking, and the operation of the work machine WM is being restricted. As a result, for example, an operation signal indicating that the automatic control is turned on is input from the automatic-control switch 54 to the control device 4.

Then, the automatic-control execution determiner 42 of the control device 4 determines, for example, that the automatic control is turned on (YES) by the operator's operation in the processing P1 as illustrated in FIG. 3. Then, the automatic-control execution determiner 42 executes, for example, processing P2 for determining whether or not the braking device 6 is turned on (in the braking state).

In this processing P2, when the braking device 6 is operated by the operator's operation as described above, the automatic-control execution determiner 42 determines that the braking device 6 is ON (in the braking state) (YES) and executes processing P3 for switching the manual operation mode to the automatic-control mode.

In this processing P3, the control device 4 invalidates, for example, at least a part of the manual control of the traveling body 1, the swivel body 2, or the work attachment 3 performed by the operator's manual operation to the manual-control execution part 41. In addition, the control device 4 validates, for example, at least the automatic control of the swivel body 2 by the automatic-control execution part 43, among the automatic control of the traveling body 1, the swivel body 2, and the work attachment 3 by the automatic-control execution part 43. Then, the control device 4 executes, for example, processing P4 for notifying the mode switching.

In this processing P4, the automatic-control execution determiner 42 outputs a control signal for notifying the mode switching to a display device 81 and an audio output device 82 included in the user interface 8, for example. As a result, an image notifying the mode switching is displayed on the display device 81. Also, the audio output device 82 outputs a sound notifying the mode switching.

Thus, the operator of the work machine WM is notified via the display device 81 and the audio output device 82 that the mode of the work machine WM has been switched from the manual operation mode to the automatic-control mode. Then, the control device 4 executes, for example, processing P5 for accepting settings related to the automatic control.

In the processing P5, the automatic-control execution part 43 of the control device 4 displays, for example, a setting screen of the automatic control via the display device 81 constituting the user interface 8. The automatic-control execution part 43 accepts, for example, settings related to the automatic control by the operator via an input device 56 such as a keyboard, an operation button, or a touch panel included in the operation device 5.

When the work machine WM is a shovel, the settings for the automatic control include, for example, input of information on a target surface for which the ground-leveling work or the slope formation work is to be performed, an excavation range targeted for the excavation work, a position of a carrying vehicle for the loading work, and the like. When the work machine WM is a crane, the settings for the automatic control include, for example, information on presence or absence of automatic anti-sway control of a suspended load, positional information on a transport destination of automatic conveyance of the suspended load, and the like.

When acceptance of the settings by the automatic-control execution part 43 is completed, the control device 4 executes processing P6 for determining whether or not the braking device 6 is turned off. In this processing P6, the automatic-control execution part 43 determines, for example, whether or not the braking device 6 is turned off by the operator operating the braking-device operation part 55, that is, whether or not the state of the braking device 6 is switched from the braking state to the non-braking state.

The operator of the work machine WM is required to sufficiently confirm the safety around the work machine WM before starting the automatic control. In addition, the operator must sufficiently confirm that the settings of the automatic control are correct before starting the automatic control. Therefore, until the operator completes the confirmation of the safety around the work machine WM and the settings, for example, the operator maintains the braking state of the braking device 6 and does not release the braking of the traveling body 1, the swivel body 2, the work attachment 3, etc.

Therefore, during the confirmation by the operator as described above, the automatic-control execution part 43 determines that the braking device 6 is not turned off in the processing P6, that is, the braking state of the braking device 6 is not released (NO). In this case, the automatic-control execution part 43 executes, for example, processing P7 for notifying the operator of the operation guidance.

In this processing P7, the automatic-control execution part 43 prompts the operator, for example, to release the braking state of the braking device 6 and switch the state to the non-braking state. Specifically, the automatic-control execution part 43 outputs a control signal to cause the display device 81 and the audio output device 82, for example, to display a predetermined image or output a predetermined sound.

As a result, an image and a sound that inform the operator of the work machine WM that it is necessary to switch the braking state of the braking device 6 to the non-braking state in order to start the automatic control is provided via the display device 81 and the audio output device 82. After that, the automatic-control execution part 43 executes processing P8 that determines, for example, whether or not the automatic control (automatic-control switch 54) is turned off.

The operator of the work machine WM, for example, maintains the automatic-control switch 54 in the ON state while confirming the safety and settings of the work machine WM before starting the automatic control. Therefore, in the aforementioned processing P8, the automatic-control execution part 43 determines that the automatic control (automatic-control switch 54) is not turned off (NO), and repeats the aforementioned processes P6 to P8 in a predetermined cycle.

When the operator of the work machine WM determines, for example, that the safety of the work machine WM is not ensured as a result of the aforementioned confirmation before the automatic control, or realizes that there is an error in the settings of the automatic control, the operator turns off the automatic-control switch 54. Then, an operation signal indicating that the automatic-control switch 54 is turned off is input from the automatic-control execution part 43 to the control device 4.

In this case, in the processing P8, the automatic-control execution part 43 determines that the automatic control (automatic-control switch 54) is turned off (YES). Thereafter, the automatic-control execution part 43 executes processing P9 for notifying the operator of the termination of automatic control P10.

In this processing P9, the automatic-control execution part 43 outputs, for example, a control signal for causing the display device 81 and the audio output device 82 to display a predetermined image or output a predetermined sound. As a result, an image and a sound notifying the termination of the automatic control P10 are provided to the operator of the work machine WM via the display device 81 and the audio output device 82. Thereafter, the control device 4 ends the processing flow as illustrated in FIG. 3 and switches the automatic-control mode to the manual control mode.

When the operator of the work machine WM confirms, for example, that the safety around the work machine WM is ensured and that there is no error in the settings of the automatic control as a result of the aforementioned confirmation before performing the automatic control, the operator of the work machine WM starts the automatic control P10. In this case, the operator performs an operation to release the braking by the braking device 6 by using, for example, the braking-device operation part 55. Specifically, the operator, for example, activates the gate lock lever included in the braking-device operation part 55 or turns off the turn-braking switch included in the braking-device operation part 55.

As a result, an operation signal for releasing the braking state by the braking device 6 and switching the braking device 6 to the non-braking state is input from the braking-device operation part 55 to the control device 4. Then, the control device 4 outputs a control signal for releasing the braking state to the braking device 6 by, for example, the automatic-control execution part 43 to switch the braking device 6 to the non-braking state and starts the automatic control P10 set in the aforementioned processing P5.

Here, the automatic-control execution part 43 may not start the automatic control P10 immediately, for example, but may wait in a state in which the automatic control P10 can be started and have the operator input a final start operation of the automatic control P10, separately. In addition, the control device 4 may start the automatic control P10 after waiting for a predetermined time period of about a few seconds after the operation signal for switching the braking device 6 to the non-braking state is input from the braking-device operation part 55.

In the automatic control P10, the automatic-control execution part 43 outputs a control signal to the drive device 7 for driving the swivel body 2 and automatically controls the operation of the swivel body 2. The automatic-control execution part 43 may automatically control the traveling body 1 and the work attachment 3 in the same manner as in the swivel body 2. As a result, the work machine WM can automatically perform, for example, ground-leveling work, slope work, excavation work, loading work, dismantling work, crushing work, sorting work, lifting work, or carrying work with preset contents without having the operator operate the operation device 5.

The automatic control P10 by the automatic-control execution part 43 may be, for example, a partial automatic control in which only a part of the configurations among the traveling body 1, the swivel body 2, and the work attachment 3 are targeted, and other configurations may be targeted by the operator's manual operation. In addition, when the operator operates the operation device 5 during the execution of the automatic control P10, the automatic-control execution part 43 may invalidate the operator's operation and continue the automatic control P10, or may give priority to the operator's operation and terminate the automatic control P10. The automatic-control execution part 43 may accept such a setting in the aforementioned processing P5.

The automatic-control execution part 43 executes, for example, processing P11 for determining whether or not the operator has turned on the braking device 6 (whether or not the non-braking state of the braking device 6 has been switched to the braking state) during the execution of the automatic control P10.

When any abnormality occurs during the execution of the automatic control P10 by the automatic-control execution part 43, the operator of the work machine WM operates the braking-device operation part 55 to operate the braking device 6. Here, the braking-device operation part 55 may include, for example, a gate lock lever, a turn-braking switch, and a foot brake or a hand brake for braking each part of the traveling body 1, the swivel body 2, or the work attachment 3.

When the operator operates the braking device 6 by using the braking-device operation part 55, a control signal corresponding to the operator's operation is output from the braking-device operation part 55 to the control device 4. When the control signal for operating the braking device 6 is input from the braking-device operation part 55, the automatic-control execution part 43 determines in the processing P11 that the operator has turned on the braking device 6, that is, that the braking device 6 has been switched from the non-braking state to the braking state (YES).

In this case, the control device 4 causes the manual-control execution part 41 to output a control signal corresponding to the operation of the operator to the braking device 6, for example, and switches the non-braking state of the braking device 6 to the braking state. Then, the automatic-control execution part 43 determines in the processing P11 that the braking device 6 has been turned on (YES), executes the aforementioned processing P7, and prompts the operator to turn off the braking device 6 and switch the braking state of the braking device 6 to the non-braking state. After that, the automatic-control execution part 43 executes the aforementioned processing P8 to determine whether or not the automatic control (automatic-control switch 54) has been turned off, and executes the aforementioned processing P6 or P9 according to a result of the determination.

On the other hand, when no abnormality occurs during the execution of the automatic control P10 by the automatic-control execution part 43, the operator does not perform the operation of turning on the braking device 6 (switching the non-braking state of the braking device 6 to the braking state) to the braking-device operation part 55. In this case, the automatic-control execution part 43 determines in the processing P11 that the braking device 6 is not turned on, that is, the non-braking state of the braking device 6 is not switched to the braking state (NO), and executes processing P12 for determining whether or not the automatic control is completed.

In the processing P12, when the automatic-control execution part 43 determines that the set automatic control has not been completed (NO), the automatic-control execution part continues the aforementioned automatic control P10 and repeats the processes P11 and P12. Additionally, in the processing P12, when the automatic-control execution part 43 determines that the set automatic control is completed (YES), the automatic-control execution part 43 executes processing P13 for notifying the operator of the completion of the automatic control.

In the processing P13, the automatic-control execution part 43 outputs, for example, a control signal for causing the display device 81 and the audio output device 82 to display a predetermined image or output a predetermined sound. As a result, an image and a sound notifying the completion of the predetermined automatic control are provided to the operator of the work machine WM via the display device 81 and the audio output device 82. Thereafter, the control device 4 terminates the processing flow as illustrated in FIG. 3 and returns the work machine WM from the automatic-control mode to the manual control mode.

When the operator of the work machine WM manually operates the operation device 5 in the manual operation mode, an operation signal corresponding to the operation of the operator is output from the operation device 5 to the control device 4. The manual-control execution part 41 of the control device 4 outputs, for example, a control signal corresponding to an operation signal input from the operation device 5 to the drive device 7 to drive the traveling body 1, the swivel body 2, and the work attachment 3 according to the operation of the operator.

During such manual operation of the work machine WM, the automatic-control switch 54 may be turned on against the operator's intention, such as when the operator mistakenly presses the automatic-control switch 54. In the manual operation mode, the control device 4 periodically executes the processing flow as illustrated in FIG. 3. When the processing flow as illustrated in FIG. 3 starts, the control device 4 executes the processing P1 by the automatic-control execution determiner 42 as described above.

When the automatic-control switch 54 is turned on against the operator's intention, an operation signal indicating that the automatic control is turned on is input from the automatic-control switch 54 to the control device 4. Then, in the processing P1, the automatic-control execution determiner 42 determines that the automatic control is turned on (YES) by the operator's operation. Thereafter, the automatic-control execution determiner 42 executes the processing P2 for determining, for example, whether or not the braking device 6 is turned on.

As described above, when the automatic-control switch 54 is turned on unintentionally during manual operation by the operator, the gate-lock lever included in the braking-device operation part 55 is not operated. Also, the operator does not turn on the turn-braking switch included in the braking-device operation part 55 except for a specific operation. Therefore, in these cases, the automatic-control switch 54 is turned on, but the braking-device operation part 55 is not being operated, and the braking device 6 is in the non-braking state (OFF).

In this case, in the processing P2, the automatic-control execution determiner 42 determines that the braking device 6 is not ON (braking state) (NO) and executes processing P14 to warn the operator. In the processing P14, the automatic-control execution determiner 42 outputs a control signal for issuing a predetermined warning to the display device 81 and the audio output device 82, for example.

As a result, the display device 81 and the audio output device 82 provide the operator with a warning including an image and a sound to notify the operator that the automatic-control switch 54 is turned on or to urge the operator to turn on the braking device 6 (switch the non-braking state to the braking state). After that, the automatic-control execution determiner 42 executes processing P15 to determine whether or not the automatic control (automatic-control switch 54) is turned off.

When the automatic-control switch 54 is unintentionally turned on during manual operation, the operator of the work machine WM receives a warning from the processing P14 and turns off the automatic-control switch 54. As a result, an operation signal indicating that the automatic-control switch 54 is turned off is input from the automatic-control switch 54 to the control device 4. In this case, in the processing P15, the automatic-control execution determiner 42 determines that the automatic control (the automatic-control switch 54) is turned off (YES) and executes processing P16 for notifying the operator that the automatic control P10 is terminated.

In the processing P16, the automatic-control execution determiner 42 outputs, for example, a control signal for performing a predetermined notification to the display device 81 and the audio output device 82. As a result, the display device 81 and the audio output device 82 provide the operator with an image and a sound indicating that the automatic control P10 is stopped. Thereafter, the control device 4 ends the processing flow as illustrated in FIG. 3 without switching the manual control mode to the automatic-control mode.

The operator who intentionally turned on the automatic-control switch 54 during the manual operation of the work machine WM but did not operate the braking device 6 keeps the automatic-control switch 54 turned on even when receiving the warning of the processing P14. The operator also operates the braking-device operation part 55 in order to turn on the braking device 6 and switch the non-braking state to the braking state upon receiving the warning of the processing P14.

As a result, an operation signal for operating the braking device 6 is input from the braking-device operation part 55 to the control device 4. Then, the manual-control execution part 41 outputs a control signal corresponding to the operation signal input from the braking-device operation part 55 to the braking device 6, and turns on and switches the braking device 6 from the non-braking state to the braking state according to the operation of the operator.

Then, in the processing P15, the automatic-control execution determiner 42 determines that the automatic control (automatic-control switch 54) is not OFF (NO), and executes the processing P2 for determining whether or not the braking device 6 is ON again. In this processing P2, the automatic-control execution determiner 42 determines that the braking device 6 is ON, that is, that the braking device 6 is in the braking state (YES). As a result, the aforementioned processes P3 to P13 are executed.

As described above, the work machine WM of the present embodiment includes the swivel body 2 configured to be pivotable, the work attachment 3 including the boom 31 mounted on the swivel body 2 so as to be raised and lowered, and the control device 4 for automatically controlling the swivel body 2. The work machine WM also includes the braking device 6 capable of switching between a braking state in which the movement of the swivel body 2 is restricted and a non-braking state in which the movement of the swivel body 2 is not restricted. Then, the control device 4 starts or sets the automatic control P10 in a state capable of being started when the braking device 6 is switched from the braking state to the non-braking state, as in the processing P6 as illustrated in FIG. 3, for example.

With this configuration, even when the operator unintentionally turns on the automatic-control switch 54 when the braking device 6 is in the non-braking state and manual operation by the operator is performed, the work machine WM of the present embodiment does not satisfy conditions for enabling the automatic control P10 of the control device 4. Therefore, it is prevented from starting the automatic control P10 against the operator's intention. In addition, even when the braking device 6 is in the braking state, the control device 4 does not satisfy conditions for enabling the automatic control P10 and the automatic control P10 is not started, such that the safety of the work machine WM control can be ensured.

On the other hand, when the operator intentionally performs the automatic control P10, it is necessary to first interrupt the manual operation to switch the braking device 6 from the non-braking state to the braking state, and then switch the braking device 6 to the non-braking state. Therefore, according to the work machine WM of the present embodiment, it is possible to enhance the safety by preventing the automatic control from starting at a timing unintended by the operator. In addition, since the braking state and the non-braking state of the braking device 6 can be switched by the operation of the braking-device operation part 55 including the gate lock lever and the turn-braking switch conventionally mounted on the work machine WM, it is possible to operate the work machine WM more safely.

Furthermore, in the work machine WM of the present embodiment, when the braking device 6 is in the braking state (ON) in the processing P2, as illustrated in FIG. 3, the control device 4 accepts an input related to the automatic control P10 such as the setting of the automatic control P10 in the processing P5.

According to the work machine WM of the present embodiment, when the operator is inputting information related to the automatic control P10 to the control device 4, the braking device 6 prevents the operation of the work machine WM that is not intended by the operator. Therefore, according to the work machine WM of the present embodiment, the safety when the control device 4 accepts an input related to the automatic control P10 can be further enhanced.

In the work machine WM of the present embodiment, when the braking device 6 is switched from the non-braking state (OFF) to the braking state (ON) after the start of the automatic control P10, as illustrated in FIG. 3, the control device 4 interrupts the automatic control P10, as illustrated in the processes P11 to P9.

According to this configuration, when any abnormality occurs during the automatic control P10, the operator switches the braking device 6 from the non-braking state to the braking state by operating the braking-device operation part 55, and the automatic control P10 can be interrupted. Therefore, according to the work machine WM of the present embodiment, the safety of the automatic control P10 can be further enhanced.

As described above, according to the present embodiment, it is possible to provide a work machine WM capable of preventing the automatic control from starting at a timing not intended by the operator.

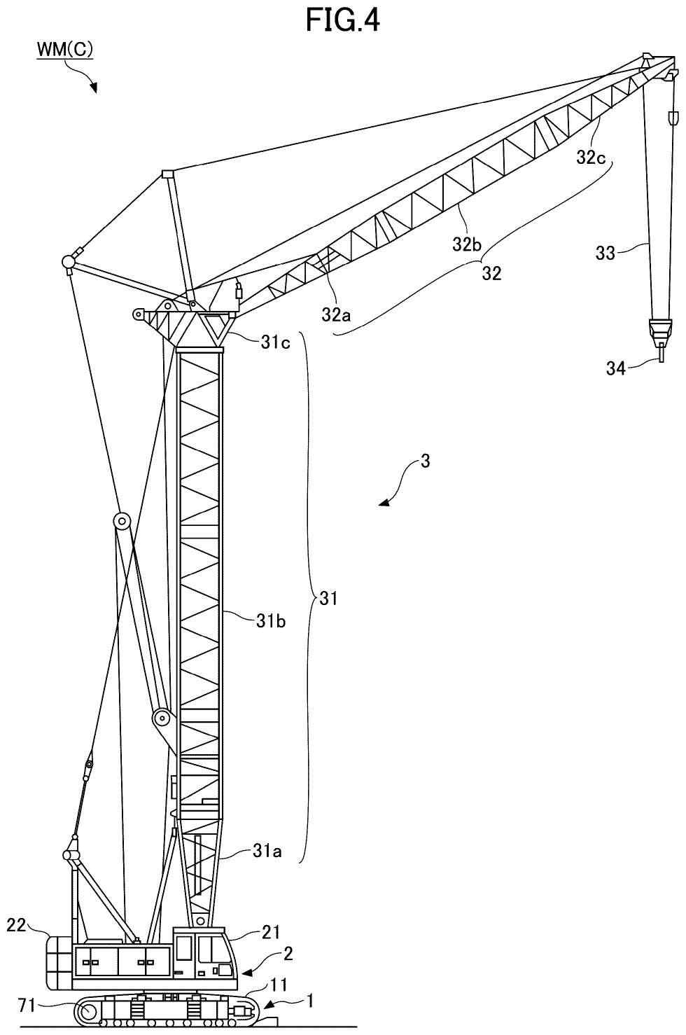

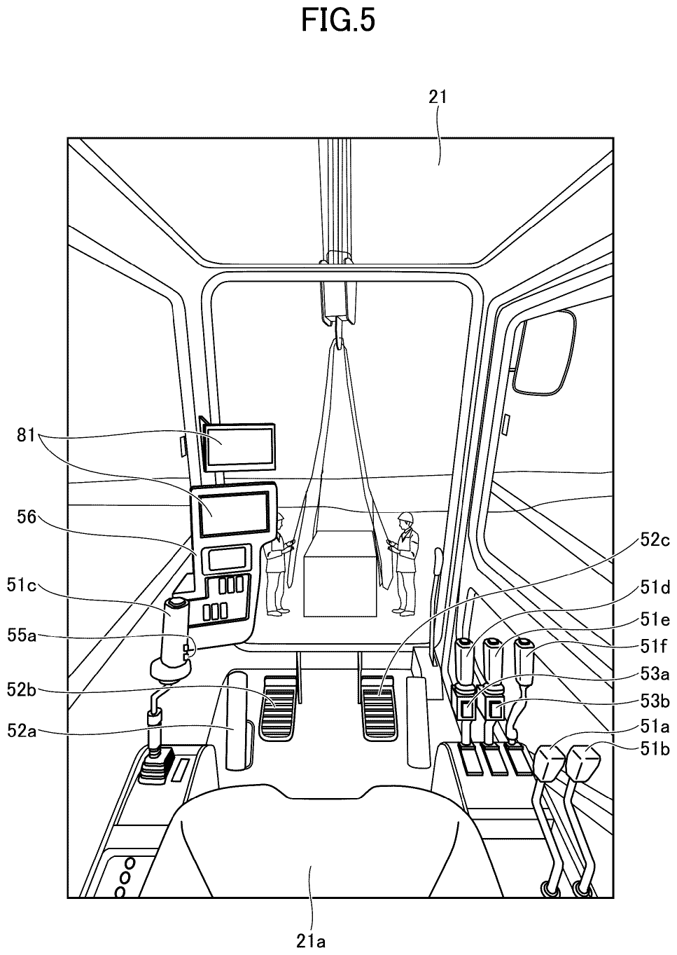

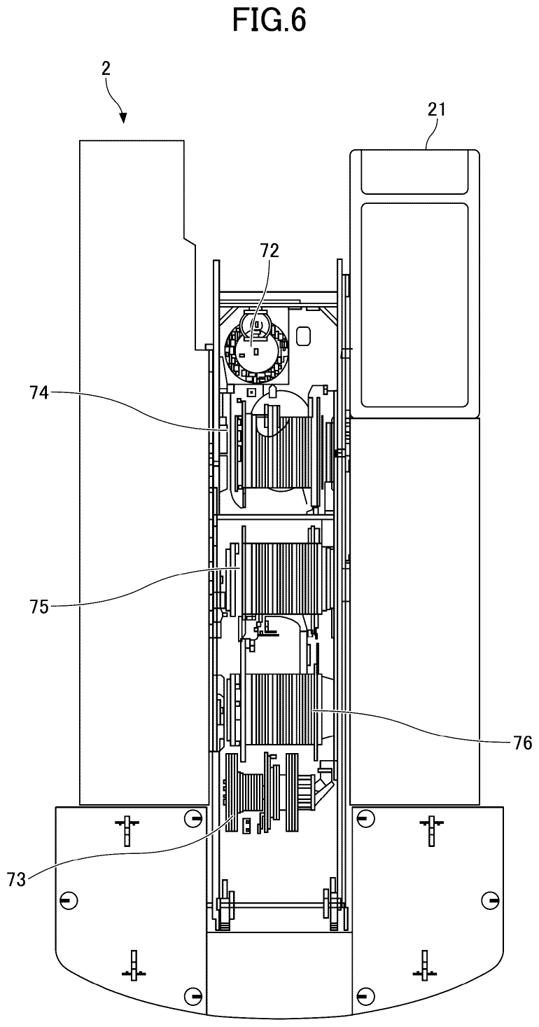

An embodiment in which the work machine WM is a crane will be described in the following with reference to FIGS. 1 to 6. FIG. 4 is a side view of a crane C as an example of the work machine WM as illustrated in FIG. 1. FIG. 5 is a perspective view around a driver's seat 21a of the crane C as illustrated in FIG. 4. FIG. 6 is a top view of the swivel body 2 of the crane C as illustrated in FIG. 4.

As illustrated in FIGS. 1 and 4 to 6, the crane C as an example of the work machine WM includes, for example, the traveling body 1, the swivel body 2, the work attachment 3, the control device 4, the operation device 5, the braking device 6, the drive device 7, and the user interface 8.

As illustrated in FIG. 4, the traveling body 1 includes, for example, left and right crawlers 11, 11 driven by the left and right traveling hydraulic motors 71, 71 included in the drive device 7 to move the crane C. When the crane C is a stationary crane, the crane C does not necessarily include the traveling body 1.

The swivel body 2 is mounted on the traveling body 1 in a pivotable manner via a slewing bearing and a center joint, for example. As illustrated in FIG. 6, for example, the swivel body 2 is driven by a slewing gear 72 included in the drive device 7 and rotates around an axis parallel to the height direction of the crane C. When the crane C is a stationary crane, the swivel body 2 may be mounted on a pedestal or a mast in a pivotable manner.

A cab 21 in which an operator rides is provided on a front right side of the swivel body 2. The control device 4 is housed under the driver's seat 21a in the cab 21 as illustrated in FIG. 5, for example. At the front center of the swivel body 2, the boom 31 of the work attachment 3 is mounted so as to be raised and lowered through a boom foot pin parallel to the width direction of the swivel body 2. A counterweight 22 is loaded on a rear portion of the swivel body 2.

As illustrated in FIG. 4, the work attachment 3 includes, for example, the boom 31 mounted on the swivel body 2 so as to be raised and lowered, a jib 32 mounted on the tip of the boom 31, and a hook 34 suspended from the tip of the jib 32 via a main rope 33. The boom 31 includes, for example, a lower tower boom 31a, a middle tower boom 31b, and an upper tower boom 31c. The jib 32 includes, for example, a lower tower jib 32a, a middle tower jib 32b, and an upper tower jib 32c.

The control device 4 starts or sets the automatic control P10 of the swivel body 2 and the work attachment 3 in a state capable of being started when the braking device 6 is switched from the braking state to the non-braking state, for example, as illustrated in the processing P6 and the automatic control P10 of FIG. 3.

Here, the automatic control P10 by the control device 4 includes, for example, the automatic anti-sway control that controls the slewing gear 72 in response to the sway of a hanging load to stop the sway of the hanging load. The automatic control P10 by the control device 4 also includes, for example, an automatic conveyance of the hanging load to move the hanging load from a first point to a second point by controlling the slewing gear 72 and at least one of a boom hoisting winch 73 or a main winch 74. The control device 4 accepts, for example, settings of the presence or absence of the automatic anti-sway control and the first point and the second point in the automatic conveyance of the hanging load in the processing P5 as illustrated in FIG. 3.

The operation device 5 is disposed around the driver's seat 21a in the cab 21, for example, as illustrated in FIG. 5. The operation device 5 includes, for example, the operation lever 51, the operation pedal 52, the operation switch 53, an automatic-control switch 54, the braking-device operation part 55, and the input device 56, as illustrated in FIG. 2.

The operation lever 51 includes, for example, a left traveling lever 51a, a right traveling lever 51b, a turn-operation lever 51c, a main-winch operation lever 51d, a supplementary-winch operation lever 51e, and a boom-hoisting-winch operation lever 51f, as illustrated in FIG. 5. The operation pedal 52 includes, for example, a turn-braking pedal 52a, a supplementary-winch braking pedal 52b, and a main-winch braking pedal 52c.

The operation switch 53 includes, for example, a main-winch braking mode-switching switch 53a provided on the main-winch operation lever 51d, and a supplementary-winch braking mode-switching switch 53b provided on the supplementary-winch operation lever 51e.

The automatic-control switch 54 is provided, for example, on the turn-operation lever 51c or the input device 56. The braking-device operation part 55 includes, for example, a turn-braking switch 55a provided on the turn-operation lever 51c.

The drive device 7 includes, for example, left and right traveling hydraulic motors 71, 71 which drive the left and right crawlers of the traveling body 1 according to the operation of the left traveling lever 51a and the right traveling lever 51b, and a slewing gear 72 which turns the swivel body 2 according to the operation of the turn-operation lever 51c. The slewing gear 72 includes, for example, a turn hydraulic motor and a speed reducer, mounted on the swivel body 2. The speed reducer of the slewing gear 72 includes, for example, a pinion engaged with a turn gear mounted on the traveling body 1.

The drive device 7 includes, for example, the boom hoisting winch 73, the main winch 74, a supplementary winch 75, and a third winch 76, as illustrated in FIG. 6. The boom hoisting winch 73 raises or lowers the boom 31 according to the operation of the boom-hoisting-winch operation lever 51f, for example. The main winch 74 winds up the main rope 33 for suspending the hook 34 from the tip of the work attachment 3 according to the operation of the main-winch operation lever 51d, for example. The supplementary winch 75 raises or lowers the jib 32 according to the operation of the supplementary-winch operation lever 51e, for example. The third winch 76 is, for example, optionally mounted on the swivel body 2.

The braking device 6 includes, for example, a turn foot brake for braking the turning of the swivel body 2 by tightening the outside of a clutch drum with a brake band or pressing the brake lining against the disc brake by operating the turn-braking pedal 52a. The braking device 6 also includes, for example, a turn brake for locking or limiting the turning of the swivel body 2 by turning on the turn-braking switch 55a provided on the turn-operation lever 51c. The turn brake is sometimes called, for example, a “turn parking brake”.

The braking device 6 also includes, for example, a supplementary-winch braking device for braking the supplementary winch 75 in response to the operation of the supplementary-winch braking pedal 52b and a main-winch braking device for braking the main winch 74 in response to the operation of the main-winch braking pedal 52c. The user interface 8 also includes, for example, the display devices 81 as illustrated in FIG. 5.

The operation of the crane C, which is an example of the work machine WM of the present embodiment, will be described in the following.

The crane C of the present embodiment as illustrated in FIGS. 4 to 6 is an example of the work machine WM described with reference to FIGS. 1 to 3. As described above, the crane C includes the swivel body 2 configured to be pivotable, the work attachment 3 including the boom 31 mounted on the swivel body 2 so as to be raised and lowered, and the control device 4 for automatically controlling the swivel body 2. The crane C also includes the braking device 6 capable of switching between the braking state in which the movement of the swivel body 2 is restricted and the non-braking state in which the movement of the swivel body 2 is not restricted. The control device 4 starts or sets the automatic control P10 in a state capable of being started when the braking device 6 is switched from the braking state to the non-braking state, as illustrated in the processing P6 and the automatic control P10 in FIG. 3.

In addition, in the crane C, which is an example of the work machine WM of the present embodiment, the braking device 6 which starts or enables the automatic control P10 is a turn brake operated by the turn-braking switch 55a to restrict the turning of the swivel body 2.

With this configuration, the crane C of the present embodiment does not satisfy the conditions for enabling the control device 4 to perform the automatic control P10 even when the operator unintentionally turns on the automatic-control switch 54 when the turn-braking switch 55a is turned off and the turn brake is in the non-braking state and manual operation is performed by the operator. Therefore, the automatic control P10 is prevented from starting against the operator's intention. In addition, even when the turn-braking switch 55a is turned on and the turn brake is in the braking state, the control device 4 does not satisfy the conditions for enabling the automatic control P10, and the automatic control P10 is not started, such that the safety of the control of the crane C is ensured.

Additionally, when the operator intentionally performs the automatic control P10, first, the manual operation is interrupted and the turn-braking switch 55a is turned on to switch the turn brake from the non-braking state to the braking state. After that, the operator must turn off the turn-braking switch 55a to switch the turn brake to the non-braking state. Therefore, according to the crane C of the present embodiment, safety can be enhanced by preventing the automatic control from starting at a timing unintended by the operator. Moreover, since the turn brake which is operated by the operation of the turn-braking switch 55a conventionally mounted on the crane C can be used, the crane C can be operated more safely.

The crane C, which is an example of the work machine WM of the present embodiment, is provided with the slewing gear 72 configured to turn the swivel body 2, the boom hoisting winch 73 configured to raise and lower the boom 31, and the main winch 74 configured to wind up the main rope 33 for suspending the hook 34 from the tip of the work attachment 3.

With this configuration, the crane C of the present embodiment can hoist the suspended load by hooking a slinging wire rope to the hook 34 and winding the main rope 33 by the main winch 74. In addition, the crane C of the present embodiment can carry the suspended load from the first point to the second point by rotating the swivel body 2 by the slewing gear 72 or by raising or lowering the boom 31 by the boom hoisting winch 73.

In addition, in the crane C as an example of the work machine WM of the present embodiment, the automatic control by the control device 4 includes control of the slewing gear 72 and control of at least one of the boom hoisting winch 73 or the main winch 74. With this configuration, the crane C of the present embodiment can perform the automatic anti-sway control of the suspended load and automatic conveyance of the suspended load more safely as described above.

As described above, according to the present embodiment, it is possible to provide a work machine WM capable of preventing the automatic control from starting at a timing unintended by the operator.

According to the above-described aspect of the present disclosure, a work machine capable of preventing automatic control from being started at a timing unintended by an operator is provided.

Thus, the preferred embodiment of the present invention has been described in detail. However, the present invention is not limited to the above-described embodiments. The above-described embodiments can be modified or replaced without departing from the scope of the present invention. The features described separately can be combined as long as there is no technical inconsistency.

What is claimed is:

1. A work machine, comprising:
a swivel body configured to be pivotable;
a work attachment provided with a boom mounted to the swivel body and configured so as to be raised and lowered;
a control device configured to perform automatic control of the swivel body; and
a braking device capable of switching between a braking state in which operation of the swivel body is restricted and a non-braking state in which the operation is not restricted, wherein
the control device starts or sets the automatic control in a state capable of being started upon switching of the braking device from the braking state to the non-braking state.

2. The work machine according to claim 1, wherein
the control device accepts an input related to the automatic control in accordance with the braking device being in the braking state.

3. The work machine according to claim 1, wherein
the braking device is a turn brake configured to restrict turning of the swivel body.

4. The work machine according to claim 3, further comprising:
a slewing gear configured to turn the swivel body;
a boom hoisting winch configured to raise and lower the boom; and
a main winch configured to wind up a main rope for suspending a hook from a tip of the work attachment.

5. The work machine according to claim 4, wherein
the automatic control further includes control of the slewing gear and control of at least one of the boom hoisting winch or the main winch.

6. The work machine according to claim 1, wherein
the control device interrupts the automatic control upon switching of the braking device from the non-braking state to the braking state after start of the automatic control.
